(19) United States
(12) Patent Application Publication
(10) Pub. No.: US 2016/0378787 A1
(43) Pub. Date: Dec. 29, 2016

(54) BROKER MEDIATED GEOSPATIAL INFORMATION SERVICE

(71) Applicant: CONTINUUM LOOP INC., Ottawa (CA)

(72) Inventor: Darrell O'DONNELL, Ottawa (CA)

(21) Appl. No.: 15/264,071

(22) Filed: Sep. 13, 2016

Related U.S. Application Data
(63) Continuation of application No. 13/733,406, filed on Jan. 3, 2013, now abandoned.
Application No. 13/733,406 is a continuation of application No. 12/155,577, filed on Jun. 6, 2008, now abandoned.
(60) Provisional application No. 60/924,938, filed on Jun. 6, 2007.

(51) Int. Cl. G06F 17/30; H04L 29/08

(52) U.S. Cl. CPC G06F 17/30241; G06F 17/30477; H04L 67/306

(57) ABSTRACT

A method includes receiving from a requestor search criteria for a geospatial information service. The requestor selects a dataset for use in providing the geospatial information service. A plurality of processes is determined, resulting in process-dataset solutions to the search criteria including the selected dataset. In particular, each process-dataset solution includes the selected dataset and a process of the determined plurality of processes. A list is provided to the requestor, the list including the plurality of process-dataset solutions.

### FIELD OF THE INVENTION

The invention relates to searching. More specifically, the invention relates to searching and retrieval of information having a geospatial component.

### BACKGROUND

Geospatial is a term that is used widely to describe the combination of spatial software and analytical methods with terrestrial or geospatial datasets. Geospatial data identifies the geospatial location and characteristics of natural or constructed features and boundaries on the earth. This information is gathered from remote sensing, mapping, surveying and other technologies. Geospatial systems capture, store, manage, integrate, display, analyze and otherwise assist in the interpretation of this data in its entire context for better decision-making.

Unfortunately, experts in data collection are typically separate and distinct from experts in data processing. In data collection, maps and other spatial information are combined to form a larger spatial dataset. For example, addresses are superimposed on a map or two maps are coupled to form a larger map. This data is then stored in a structure that is suitable for processing thereof. Once a dataset is formed, it becomes available for analysis. Experts in geospatial data analysis develop processes that are designed to operate with the data structure to extract from the dataset “useful” information. For each problem that is encountered, an expert is consulted to design a process that allows the problem to be better analysed, avoided, or solved. Since the process is designed for a given dataset and for solving a given solution, the process designer can ensure that the process functions within specifications and, once designed, the process can be executed on the dataset in a repeatable fashion.

As is true of information in general, the volume of available geospatial data is expanding continuously, thereby providing process developers with new opportunities to develop improved processes that enable decision makers to make better and more informed decisions. That said, most process developers are well versed in specific datasets thereby limiting the available datasets for their processes. Furthermore, many organisations already have access to specific datasets, and as such, tend only to work with process developers that are already versed in processing those datasets. Despite this tendency, some processes are executable on datasets other than the ones for which the process was developed initially. In some cases, the same process may yield different geospatial information depending on the dataset that is being analyzed. That is to say, the geospatial information may be biased in some way as a result of the way each dataset was created, such as for instance either during collection of the geospatial data itself or in the way the structure of the dataset was defined. Similarly, different processes executed on the same dataset may yield different geospatial information depending upon the particular bias that is built into each different process.

It would be beneficial to provide an improved method and system that overcomes at least some of the above-mentioned limitations.

### SUMMARY OF THE INVENTION

In accordance with an aspect of the invention there is provided a method comprising: receiving from a requestor a search criteria for a geospatial information service; selecting a dataset for use in providing the geospatial information service; determining a plurality of processes resulting in process-dataset solutions to the search criteria, each process-dataset solution comprising the selected dataset and a process of the determined plurality of processes; and providing to the requestor a list comprising the plurality of process-dataset solutions.

In accordance with an aspect of the invention there is provided a method comprising: receiving from a requestor a search criteria for a geospatial information service; selecting a dataset for use in providing the geospatial information service; deter mining a plurality of processes resulting in process-dataset solutions comprising the selected dataset to the search criteria, each process-dataset solution comprising at least a process and at least a dataset to process with the at least a process; and providing to the requestor a list comprising the plurality of process-dataset solutions.

### BRIEF DESCRIPTION OF THE DRAWINGS

Embodiments of the invention are now described with reference to the figures in which:

FIG. 1 is a simplified view of a navigation system for use in an automobile;

FIG. 2 is a flowchart of a method according to an embodiment of the invention;

FIG. 3 is a flowchart of a method according to another embodiment of the invention;

FIG. 4 is a flowchart of a method according to another embodiment of the invention;

FIG. 5 is a flowchart of a method according to another embodiment of the invention; and,

FIG. 6 is a flowchart of a user feedback mechanism.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

Throughout the detailed description and in the appended claims, the following terms are to be accorded the following definitions:

Location—is defined as a position in space, where position may be represented by a point, line, polygon, or volume in 3-dimensional space.

Requestor—is defined as either a human user of the broker mediated geospatial information service, or as a process in execution on a system for providing a service to a human user or to another system. For example, the process in execution comprises an agent having user preferences provided thereto such that the agent searches for and engages geospatial information services on behalf of the human user.

Process—is defined as an implementation of a method for processing, filtering, combining, or searching geospatial information within one or more datasets. A process optionally includes plural processes operating on one or more dataset in parallel, in series, or in some other way. Though a dataset is typically a stored dataset, it is also optionally a second dataset resulting from application of one or more processes to a first dataset.

Search criteria—is defined as a set of parameters, rules and/or policies that is specified by a requestor in order to define a request for specific geospatial information. By way of several specific and non-limiting examples, the set of parameters optionally includes any of the following: the current location of the requestor, the destination of the requestor, a complete or partial itinerary of the requestor, a planned travel route of the requestor, requestor preferences (i.e. profile data such as: the requestor likes to walk between itinerary points, the requestor likes to sleep/eat within a certain distance of public transit stops, the requestor requires an eating establishment that caters to specific dietary requirements, the requestor enjoys live theater, the requestor likes to shop at high-end jewelry boutiques, or any other profile data that may be specified in order to refine the searching process). Other parameters and/or rules may be envisaged, depending upon the nature of the request, etc.

Geospatial information service—is defined as the processing of a dataset to obtain a result in accordance with the set of parameters and/or rules as defined in the search criteria. The dataset comprises geospatial information, including location and characteristic data relating to natural and constructed features. The act of performing the geospatial information service includes providing to the requestor the result so obtained. Different geospatial information services are considered to result when the same process is executed on different datasets, or when different processes are executed on the same dataset.

Process-dataset solution—is defined as a specific process and dataset grouping, as determined by a geospatial information service broker, for performing a requested geospatial information service. Depending on the geospatial information service that is requested, plural process-dataset solutions may be available. In the case of a simple geospatial information service, the process-dataset solution includes only a specific process and a specific dataset. When executed on the specific dataset, the specific process returns a result in accordance with the set of parameters as defined in the search criteria. Optionally, the process-dataset solution includes plural processes for being executed on one or plural datasets. Further optionally, results of one processing step are further processed using additional processes or are combined with additional datasets. Further optionally, the process-dataset solution is provided in a step-wise fashion. For instance, the geospatial information service broker provides initially a plurality of available processes only. The requestor selects one process of the plurality of available processes, and is presented subsequently with a list of available datasets.

Value indicator—is defined as information that is provided to the requestor in association with the process-dataset solution. In particular, the value indicator relates to a ranking of the process-dataset solution, or alternatively to a ranking of individual components of the process-dataset solution. The value indicator optionally is either qualitative or quantitative. The value indicator optionally is provided in the form of a numeric scale, an alphabetic scale, a symbol-based scale (e.g. happy face/neutral face/smiley face, thumbs-up/thumbs-down, a star-rating, pie-chart etc.), or in any other form that can convey to the requestor the value of one process-dataset solution relative to another process-dataset solution. Of course, since the requestor may be a process in execution on a system, the value indicator need not even be provided in a human intelligible form. Furthermore, the value indicator may simply be implied based on the ordering of the process-dataset solutions in a list.

Geospatial information service broker—is defined as a system that is disposed between the requestor and a plurality of geospatial information service providers. The geospatial information service broker determines a plurality of process-dataset solutions that relate to the search criteria as provided by the requestor. The geospatial information service broker also maintains a database of value indicators including at least one value indicator that is stored in association with each process-dataset solution, or with the component process and dataset of each process-dataset solution. Additionally, the geospatial information service broker provides to the requestor a list including at least some of the plurality of process-dataset solutions and at least one value indicator associated with each process-dataset solution.

Geospatial information service provider—is defined as a system that provides for the implementation of a selected process-dataset solution and then provides a result of the process-dataset solution to the requestor. Often the geospatial information service provider includes a processor for executing the process-dataset solution, but this need not be the case. Optionally, the geospatial information service broker includes a geospatial information service provider.

Dataset provider—provider of a geospatial information dataset.

Process provider—a provider of a process for processing geospatial information datasets.

Advertising Provider—a provider that specifically provides advertising services for display to a consumer.

Aggregation server—a server of a broker-mediated geospatial information service environment for aggregating feedback data.

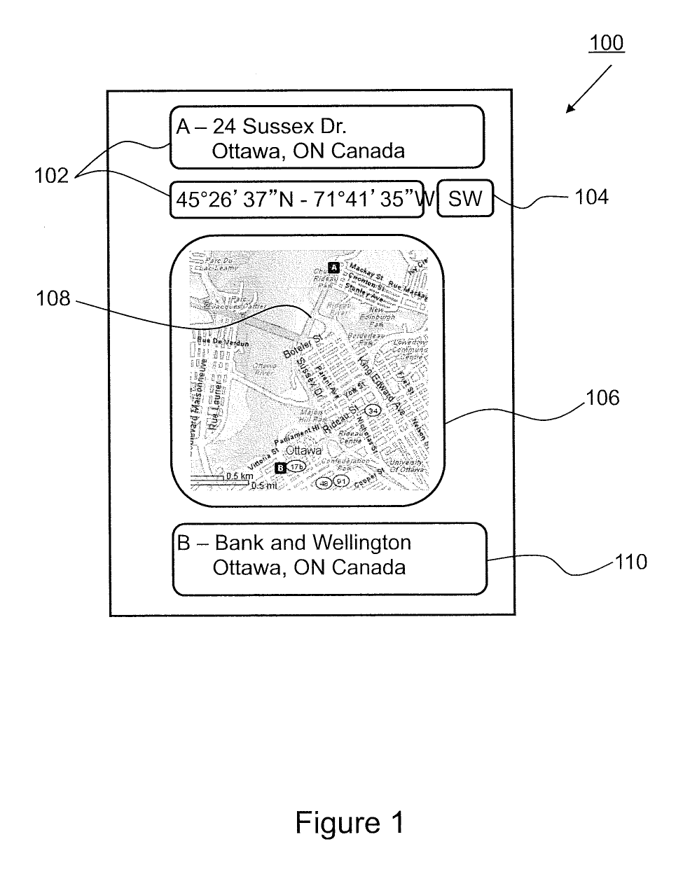

Referring to FIG. 1, shown is a simplified view of a navigation system 100 for use in an automobile. The navigation system 100 displays a current automobile location 102, such as for instance in the form of one or more of a street address, an intersection or latitude and longitude coordinates, and a current automobile orientation 104 determined based on GPS data and compass data. The navigation system 100 also shows a map 106 of the area about the current location and, highlights a suggested route 108. Below the map is an indication of a destination 110 for which the suggested route is determined.

As is evident, the automobile navigation process is a dedicated process having a single process operating on a single dataset. Advantageously, such a system is easily subjected to quality assurance to ensure that the operation thereof is satisfactory. Further, such a system is easily commercialized as it is sold as a whole. Problematically, should an improved process or dataset become available from another source, neither can be substituted within the system without replacing the entire system.

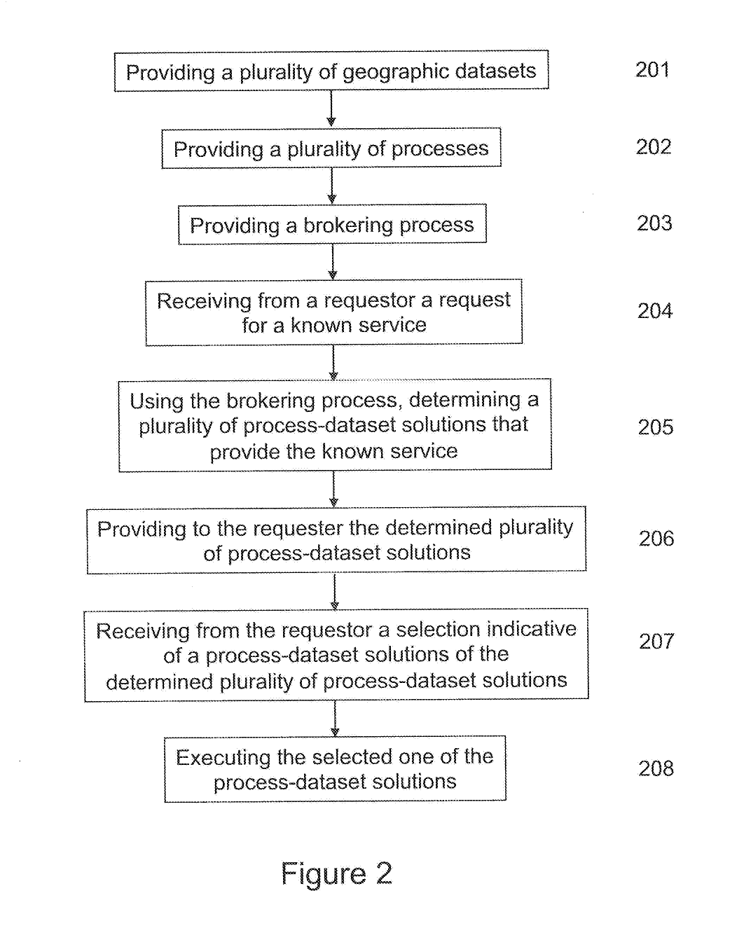

Referring to FIG. 2, shown is a simplified flow diagram of a method of brokering geospatial information system data, according to an embodiment of the instant invention. A plurality of geospatial datasets is provided at 201. A plurality of processes is provided for processing of the plurality of geospatial datasets at 202. A geospatial information service broker is provided for providing search and brokering functionality at 203.

At 204 a request is received from a requestor for a known geospatial information service. The known geospatial information service is defined within the geospatial information service broker. The geospatial information service broker determines a plurality of process-dataset solutions that provide the known geospatial information service at 205. The determined plurality of process-dataset solutions is provided to the requester at 206. The requester then selects a process-dataset solution, step not shown in simplified flow diagram. At 207 an indication of the selected process-dataset solution is received from the requestor. At 208 the selected one of the process-dataset solutions is then executed, providing the known geospatial information service to the requester.

Typically, a process-dataset solution comprises a process and a dataset on which to execute the process. Alternatively, a process-dataset solution comprises a dataset and a plurality of processes for being executed in series on the dataset. Alternatively, a process-dataset solution comprises a process and a plurality of datasets for being processed with the process. Further alternatively, a process-dataset solution comprises a plurality of datasets and a plurality of processes, each process for processing either a dataset from the plurality of datasets or data provided by processing of a dataset from the plurality of datasets. Thus, very complex geospatial information services involving overlaying geospatial data from different datasets and processing of same, are supported.

Advantageously, geospatial information services are definable using existing processes and datasets or involving new processes and datasets or involving a mixture of new and existing processes and datasets.

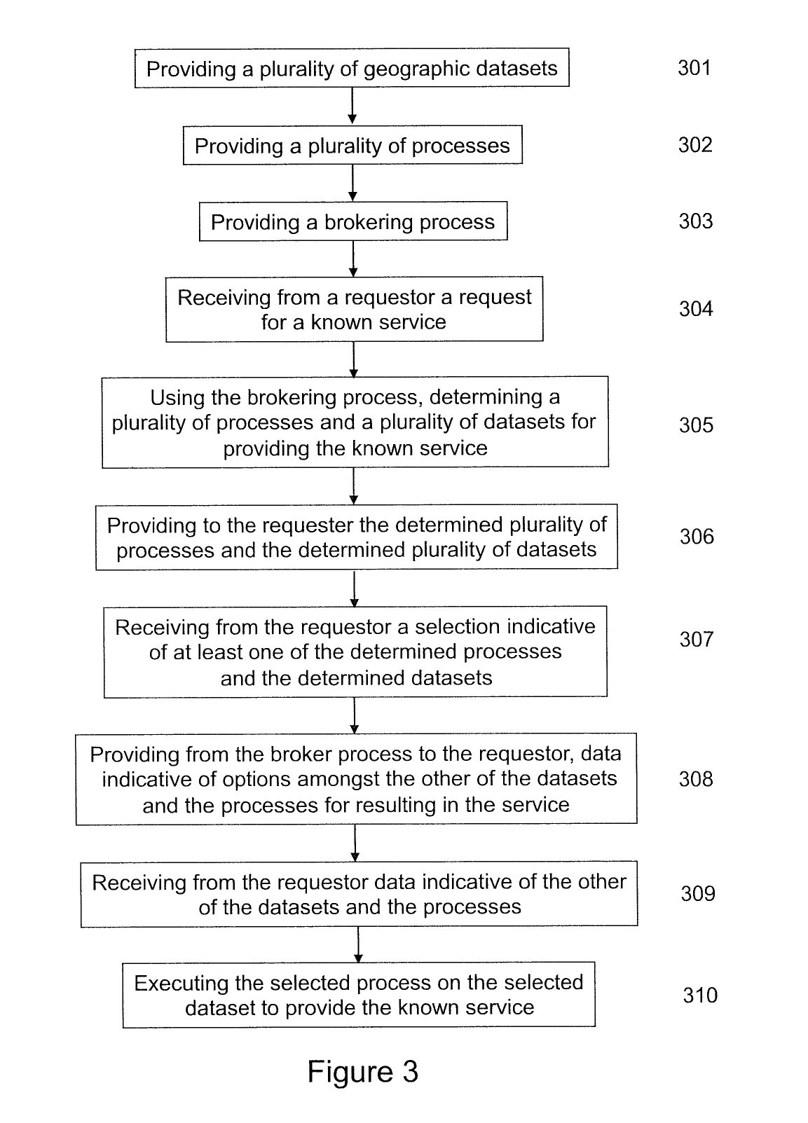

Referring to FIG. 3, shown is a simplified flow diagram of a method according to another embodiment of the invention. A plurality of geospatial datasets is provided at 301. A plurality of processes is provided for processing of the geospatial datasets at 302. A geospatial information service broker is provided for providing search and brokering functionality at 303.

A request is received from a requester for a known geospatial information service at 304. The known geospatial information service is defined within the geospatial information service broker. The geospatial information service broker determines a plurality of processes and a plurality of datasets for providing the known geospatial information service at 305. The determined processes and datasets are provided to the requester at 306. The requester then selects one of a dataset and a process, and at 307 a selection is received from the requestor that is indicative of at least one of the determined processes and the determined datasets. The geospatial information service broker then provides data to the requester that is indicative of options amongst the other of the datasets and the processes for resulting in the geospatial information service at 308. At 309 data indicative of the other of the datasets and the processes is received from the requestor, and the process is executed on the dataset at 310 to result in performing the known geospatial information service.

Of course, more complex services optionally result from several processes and/or application of those processes to several datasets. Thus, selection of one of a process and a dataset optionally results in further dataset options as well as options of available processes. Alternatively, the method of FIGS. 2 and 3 are combined such that processes operating on datasets and resulting in further datasets for use with other processes are determined as pairings and provided either as a pairing or as a resultant dataset, thus simplifying a selection process.

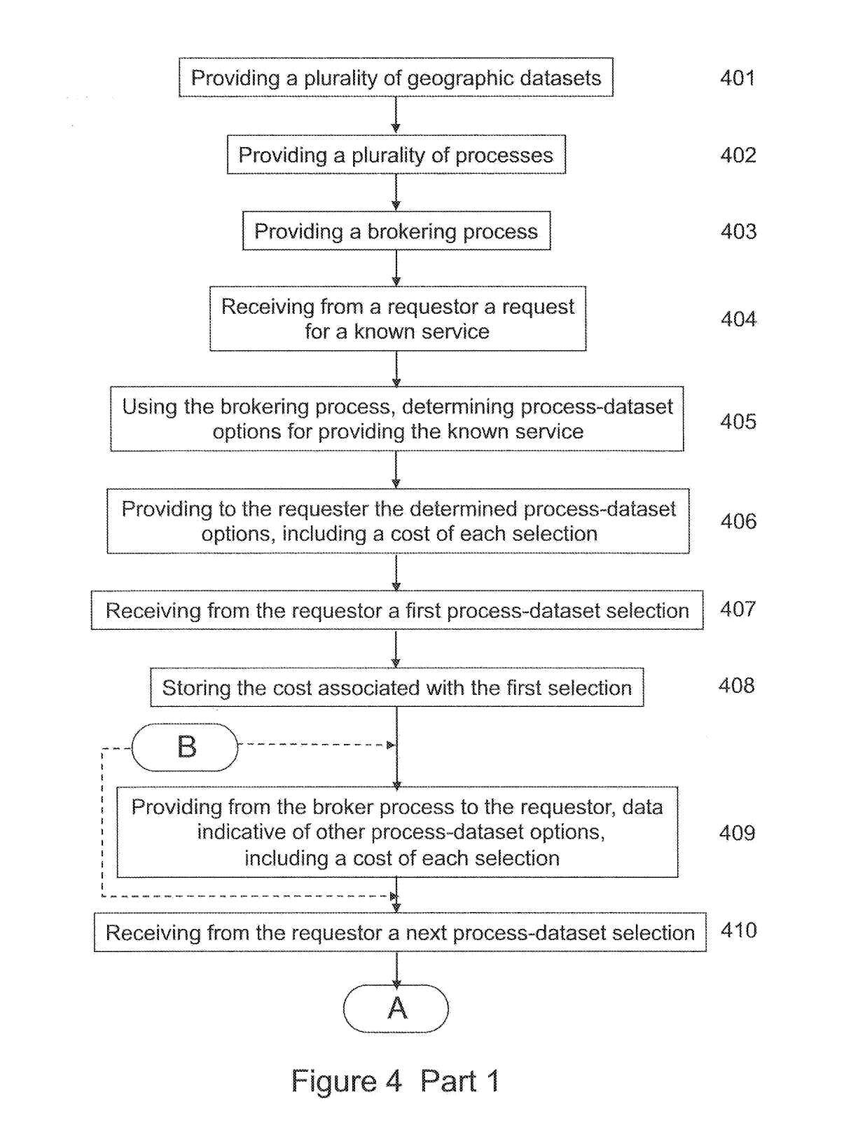

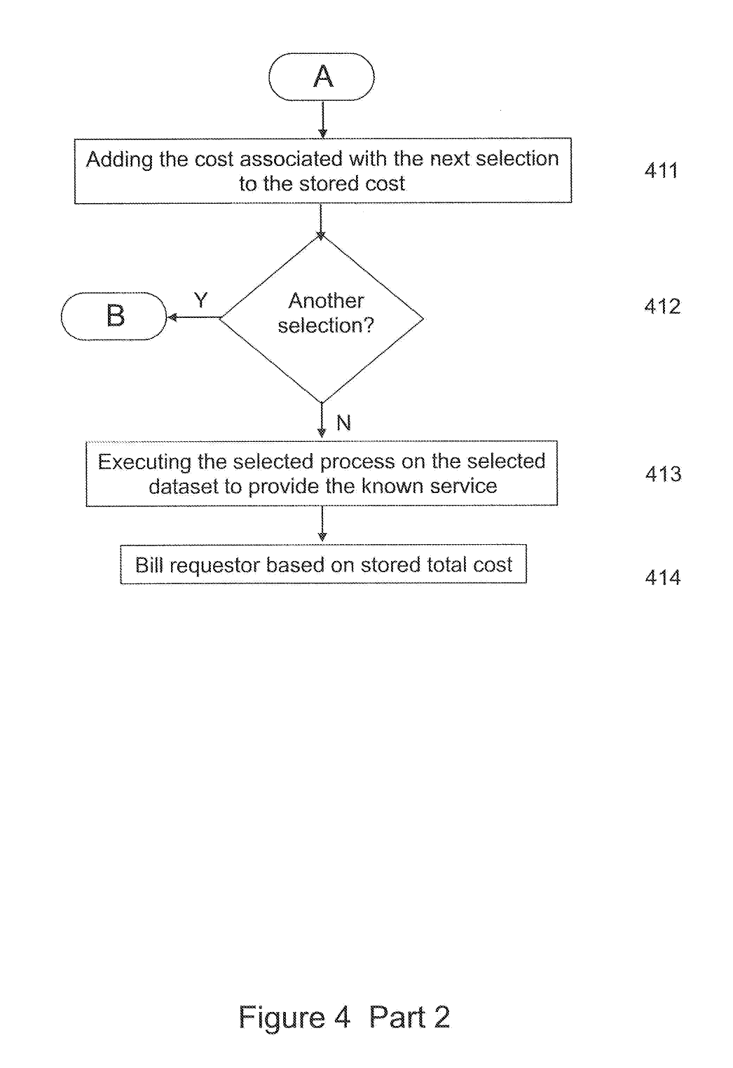

Referring to FIG. 4, shown is a simplified flow diagram of a method according to another embodiment of the invention. The method of FIG. 4 is performed using a geospatial information service system including a transaction management system, which supports billing and commerce functionality Here, a geospatial information service broker similar to those of the previous embodiments is provided. A plurality of geospatial datasets is provided at 401. A plurality of processes is provided for processing of the geospatial datasets at 402. A geospatial information service broker is provided for providing search and brokering functionality at 403. A request is received from a requester for a known geospatial information service at 404. The known geospatial information service is defined within the system. The geospatial information service broker determines process-dataset options for providing the known service at 405. For instance, the geospatial information service broker determines a plurality of processes and a plurality of datasets for providing the known geospatial information service, in which case the determined processes and datasets are provided to the requester at 406. Optionally, the geospatial information service broker determines a plurality of process-dataset solutions for providing the known geospatial information service at 405, in which case the determined plurality of process-dataset solutions is provided to the requester at 406.

Upon returning process-dataset options to the requester at 406, cost information is included indicating a cost of each solution. As selections are received from a requester, a total cost of the selected service is determined and provided to the requester. For example, at 407 a first process-dataset selection is received from the requestor and at 408 a cost associated with the first selection is stored. At 409 data indicative of other process-dataset solutions, including a cost of each selection, is provided from the geospatial information service broker to the requester. At 410 a next process-dataset selection is received from the requester and at 411 a cost associated with the next selection is added to the stored cost. If no additional selections are indicated at 412, then the process is executed on the dataset at 413 to result in performing the known geospatial information service. At 414 invoicing is accomplished through any of a number of mechanisms including monthly invoicing, per service invoicing, etc., based on the stored total cost. If additional selections are indicated at 412 then the method returns either to 409 to provide refreshed data that is indicative of other process-dataset options, including a cost of each selection, or the method returns to 410 to receive from the requestor another next selection directly without providing refreshed data. The additional cost that is associated with each additional selection is added to the stored total cost, and eventually the total cost is invoiced at 414 after all selections have been made. For example, the requester is invoiced for the total cost. Of course, invoicing is optionally done to other parties such as advertisers, vendors, and so forth who derive value from or are willing to pay the geospatial information service broker.

By way of a specific and non-limiting example, a simple request requires a search for several different things: a coffee shop, with a particular brand preferred, men's shoes of another particular brand, and a fine wine store. The requester is a businessman that is traveling out of town. Upon issuing a request to be able to go out for a coffee, look at new shoes, and potentially purchase some wine for his wine cellar, the service broker engages many different process-dataset solutions and determines that there are some fee-based services. The requester is shown a list of available services and selects several services: one that optimizes his travel path (i.e. routing), one that locates his favourite coffee store for which be receives a small search subsidy, one of several that lists shoe vendors that early his favourite brand and is free for use, and a fee-based service from a members-only wine club that his hometown wine club has an affiliation with. The broker service consolidates the list of locations for the coffee, shoes, and wine, and then uses the fee-based path optimization to present a route plan for the requestor.

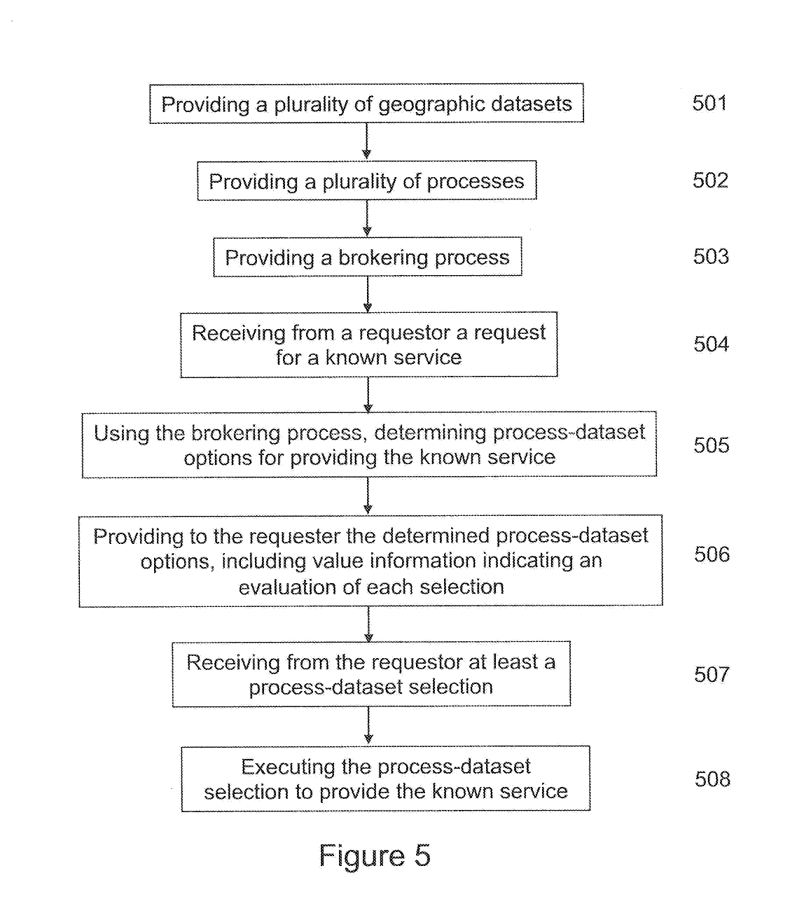

Referring to FIG. 5, shown is a simplified flow diagram of method according to another embodiment of the invention. The method of FIG. 5 is performed using a geospatial information system including a transaction management system providing for ratings and feedback. Here, a geospatial information service broker similar to those of the previous embodiments is provided. A plurality of geospatial datasets is provided at 501. A plurality of processes is provided for processing of the geospatial datasets at 502. A geospatial information service broker is provided for providing search and brokering functionality at 503. A request is received from a requester for a known geospatial information service at 504. The known geospatial information service is defined within the system. The geospatial information service broker determines process-dataset options at 505. For instance, the geospatial information service broker determines a plurality of processes and a plurality of datasets for providing the known geospatial information service, in which case the determined processes and datasets are provided to the requester at 506. Optionally, the geospatial information service broker determines a plurality of process-dataset solutions for providing the known geospatial information service at 505, in which case the determined plurality of process-dataset solutions is provided to the requester at 506.

Upon returning the process-dataset options to the requester at 506, value indicators are included indicating a relative ranking of at least some of the options and typically of each of the options. The requester is then able to evaluate processes and datasets in accordance with the value indicators. Optionally, the value indicator is based upon statistical feedback data of other requestors or is based upon previous feedback data of the requestor. In such cases, the value information is determined by a user feedback mechanism. Optionally, the value information is based upon expert analysis or is based upon other analysis of the feedback data. At 507 at least a process-dataset selection is received from the requestor. At 508 the process-dataset selection is executed to result in performing the known geospatial information service.

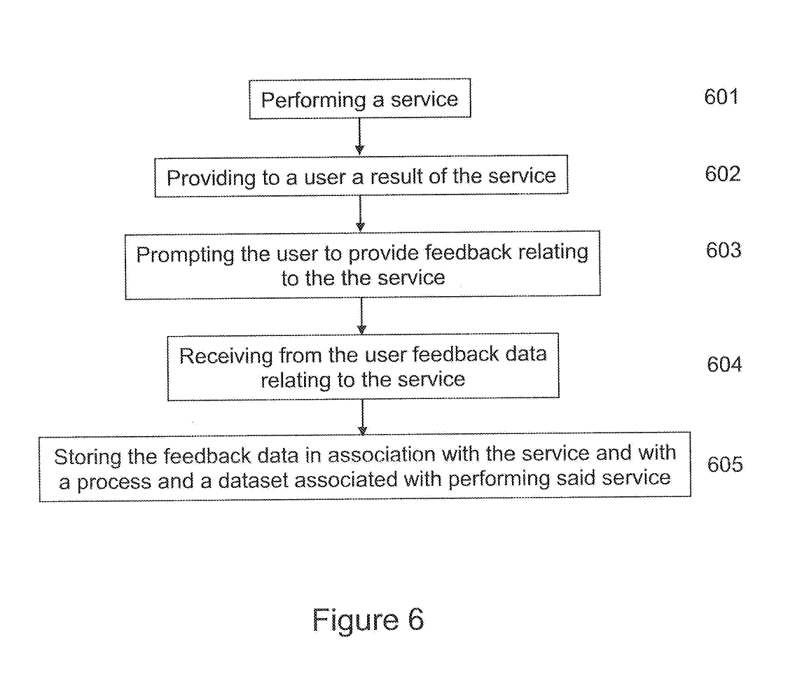

Referring to FIG. 6, shown is a user feedback mechanism. Here a geospatial information service is performed at 601 and a result of the geospatial information service is provided to a requester at 602. A user who receives the output result from the geospatial information service is then prompted to provide feedback at 603. At that time, or alternatively at a later time, the user provides feedback data relating to the geospatial information service, which is received at 604. At 605 the feedback data is stored in association with the geospatial information service and with a process and a dataset associated with performing said geospatial information service. The feedback data, when statistically aggregated, provides value information relating to ranking of one or another process and/or dataset.

Though a dataset is typically a stored dataset, it is also optionally a dataset resulting from application of one or more processes. For example, a map of a city with coffee shops highlighted is a dataset whether or not it is stored in that form or formed by processing of a map to overlay coffee shop locations thereon.

It will be evident to one of skill in the art that a process is applicable to more than one format of dataset either by design or through a use of a process that transforms one of the dataset format or the process-dataset interface rendering the process compatible with the dataset. As such, provided processes and datasets may include processes for transforming a dataset or, alternatively, a dataset transformed by a process.

Numerous other embodiments may be envisaged without departing from the spirit and scope of the invention.

What is claimed is:

1. A method comprising:
providing a geospatial request for results of a geospatial analysis of geospatial data including location and characteristic data relating to natural and constructed features and boundaries on the Earth from a first system to a second other system;
receiving at the first system from the second other system a plurality of different process-dataset solutions for geospatially processing said request, each process-dataset solution comprising a dataset comprising location and characteristic data relating to natural and constructed features and boundaries on the Earth and a geospatial information process for geospatially processing said dataset of the process-dataset solution, some process-dataset solutions for providing different results;
providing from the first system to the second other system a user selection between the process-dataset solutions; and
in response to the user selection receiving at the first system from the second other system a result of processing according to the user selection the process-dataset solution in accordance with a geospatial combination of spatial software and analytical methods upon terrestrial and/or geographic datasets.

2. A method according to claim 1 where the geospatial request comprises a request for being responded to by processing a combination of spatial software and/or analytical methods with terrestrial or geospatial datasets.

3. A method according to claim 1 comprising determining the plurality of process dataset solutions, the plurality of process dataset solutions different for different geospatial requests.

4. A method according to claim 3 comprising: determining a plurality of datasets for displaying to a requestor who provided the request at the first system a list comprising the plurality of datasets.

5. A method according to claim 4 wherein,
selecting is performed by the requestor and comprising:
billing one of the requestor and a user associated with the requestor a predetermined amount for execution of the process-dataset solution.

6. A method according to claim 1 comprising:
billing a party associated with the selected process dataset solution a predetermined amount for execution of the process-dataset solution.

7. A method according to claim 1 comprising:
paying a process/dataset provider of at least a process within the process-dataset solution in dependence upon execution of the process-dataset solution.

8. A method according to claim 1 comprising:
displaying advertising data from an advertiser to the requestor in association with at least one of displaying the process-dataset solutions and executing a process-dataset solution and wherein paying is performed from the advertiser to at least one process/dataset provider.

9. A method according to claim 8 wherein,
the process/dataset provider comprises a plurality of providers, comprising a dataset provider and a service provider.

10. A method according to claim 1 wherein,
a process-dataset solution of the resulting process-dataset solutions comprises a process for execution on a resulting dataset, the resulting dataset resulting from an execution of another process upon a first dataset.

11. A method according to claim 1 comprising:
determining a value indicator for a process-dataset solution based on usage statistics relating to the process-dataset solution.

12. A method according to claim 1 comprising:
providing a user profile for a user;
determining individuals with similar profiles to the user profile; and
providing value indicators associated with the determined individuals.

13. A method according to claim 12 wherein,
the user profile is provided by the user.

14. A method according to claim 12 wherein,
the user profile is determined based on user usage data.

15. A method according to claim 1 wherein each dataset comprises addresses superimposed on a map.

16. A method according to claim 1 wherein each dataset comprises two maps coupled to form a larger map.

17. A method comprising:
receiving a geospatial request for results of a geospatial analysis of geospatial data including location and characteristic data relating to natural and constructed features and boundaries on the Earth;
providing, in response to the geospatial request, a plurality of different process-dataset solutions for geospatially processing said request, each process-dataset solution comprising a dataset comprising location and characteristic data relating to natural and constructed features and boundaries on the Earth and a geospatial information process for geospatially processing said dataset of the process-dataset solution, some process-dataset solutions for providing different results;
receiving from a user, a user selection between the process-dataset solutions;
in response to the user selection, processing according to the user selection the process-dataset solution in accordance with a geospatial combination of spatial software and analytical methods upon terrestrial and/or geographic datasets; and
providing the result in accordance with results of the processing.

18. A method according to claim 17 wherein,
search criteria is provided by a user and comprising:
displaying a list of the process-dataset solutions to the requestor; and
after executing the process-dataset solution, displaying to the requestor a result thereof.

19. A method according to claim 17 comprising:
displaying for at least two of a plurality of process-dataset solutions a value indicator, the value indicator for use in determining a relative ranking of the at least two process-dataset solutions.

20. A method comprising:
receiving from a requestor a search criteria for a geospatial information service;
selecting at least a dataset for use in providing the geospatial information service, the dataset comprising geospatial data including location and characteristic data relating to natural and constructed features and boundaries on the Earth;
selecting a plurality of processes resulting in process-dataset solutions comprising the at least a selected dataset to the search criteria, each process-dataset solution comprising at least a process and the at least a selected dataset comprising geospatial data including location and characteristic data relating to natural and constructed features to process with the at least a process; and
providing to the requestor a list comprising the plurality of process-dataset solutions.
